(19) United States
(12) Patent Application Publication
(10) Pub. No.: US 2025/0356115 A1
(43) Pub. Date: Nov. 20, 2025

(54) MODULARIZED AND EXTENSIBLE FRAMEWORK FOR VISUALIZATION-TO-CAPTION GENERATION

(71) Applicant: Adobe Inc., San Jose, CA (US)

(72) Inventors: Shunan GUO, San Jose, CA (US); Yeuk-Yin Chan, San Jose, CA (US); Wei Zhang, Great Falls, VA (US); Victor Soares Bursztyn, Redwood City, CA (US); Prithvi Bhutani, Lynnwood, WA (US); Jane Elizabeth Hoffswell, Seattle, WA (US); Eunyee Koh, Sunnyvale, CA (US)

(21) Appl. No.: 18/663,531

(22) Filed: May 14, 2024

(51) Int. Cl. G06F 40/186; G06F 16/901; G06F 40/169

(52) U.S. Cl. CPC G06F 40/186; G06F 16/9024; G06F 40/169

(57) ABSTRACT

Some aspects relate to technologies providing a framework for generating captions from chart visualizations. In accordance with some aspects, input data for a chart is received that includes an indication of the chart type and chart data for the chart. Using the chart data, insight data is determined for each of a number of insight types defined for the chart type. The insight data can be generated using a rule set defined for each insight type. Using the insight data, a caption is generated with natural language text for each insight type. A user interface is provided that includes the chart and at least one of the captions.

### BACKGROUND

Network-based computing systems, such as the Internet, have enabled the collection of very large and complex datasets, which are stored in repositories such as databases, data lakes, or cloud storage. Data analysis systems facilitate retrieving data from the datasets by providing efficient querying mechanisms and processing capabilities. These systems enable extracting, transforming, and analyzing the collected data to derive insights, make informed decisions, and drive strategies that are typically not otherwise possible given the vast amount of collected and stored data. Such data analysis systems often include charting functions that provide chart visualizations depicting selected data to facilitate, among other things, monitoring complex datasets and making data-driven decisions.

### SUMMARY

Some aspects of the present technology relate to, among other things, a modularized and extensible framework for extracting insights from charts and generating captions for the extracted insights. In accordance with the technology described herein, a data analysis system defines insight types for each of a number of different chart types. A rule set is defined for each insight type that provides instructions for extracting certain insight data for each insight type. In operation, the data analysis system receives input data for a chart that includes an indication of the chart type and the underlying chart data used to generate the chart. In some instances, the input data can also include configuration information with additional parameters for generating insights. Based on the chart type, the data analysis system generates insights by extracting insight data from the chart data for each insight type defined for the chart type based on its corresponding rule set. A caption can then be generated for each insight using its insight data. In some aspects, a template-based approach is used for caption generation in which the data analysis system stores templates corresponding to the insight types, where each template includes natural language text and placeholders. To generate a caption for an insight of a given insight type, the data analysis system retrieves a template for the insight type and replaces the placeholders with the insight data for the insight. In further aspects, the data analysis system generates ranking scores for the insights to facilitate selecting captions to generate/present with the chart and/or ordering the presentation of the captions with the chart.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIGS. 2A-2C are diagrams showing example input data for extracting insights from charts and generating captions for the insights in accordance with some implementations of the present disclosure;

FIG. 3 is a diagram showing an example template for generating a caption in accordance with some implementations of the present disclosure;

FIGS. 4A-4D are diagrams showing user interfaces presenting captions for a chart in accordance with some implementations of the present disclosure;

FIG. 5 is a flow diagram showing a method for extracting insights from a chart and generating captions for the insights in accordance with some implementations of the present disclosure;

FIG. 6 is a flow diagram showing a method for using a template for a given insight type to generate a caption in accordance with some implementations of the present disclosure; and

FIG. 7 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, a “chart” refers to a visual representation of data, used to illustrate, for instance, patterns, trends, and relationships in the data. Charts employ visualizations, such as graphs, diagrams, or tables, to make complex information more accessible and understandable.

A “chart type” refers to a type of visualization used by a chart. Examples of various chart types include line charts, area charts, bar charts, donut charts, histograms, fallout visualizations, and Sankey diagrams.

The term “chart data” is used herein to refer to data used to generate a chart. The chart data can comprise structured data employing a schema using attributes. For instance, the structured data can comprise tabular data represented as a table in rows and columns, where each row corresponds to a record, and each column corresponds to an attribute. However, structured data in other formats, such as graph data, can be employed. An attribute (e.g., a column in tabular data) corresponds to a dimension, metric, characteristic, feature, or property within the schema of the structured data. An attribute is identified using an attribute name and can comprise attribute values that are either numerical data (i.e., a numeric attribute) or non-numerical data (i.e., a non-numeric attribute). Numerical data comprises data in the form of numbers, including discrete or continuous values. Non-numerical data comprises data in the form of names or labels.

An “insight” refers to information gleaned from a chart that provides a deeper understanding or realization obtained by interpreting the patterns, trends, or relationships depicted in the visualized chart data. Insights can provide, for instance, meaningful conclusions or actionable information from the visual representations provided by charts.

An “insight type” refers to the type of information gleaned from a chart for insight. In accordance with aspects of the technology described herein, a set of insight types are defined for each chart type. For instance, the set of insight types for a single line chart can include: a maximum insight providing information regarding a maximum value in the line chart, a minimum insight providing information regarding a minimum value in the line chart, a spike insight providing information regarding a spike in values in the line chart, a decline insight providing information regarding a decline in values in the line chart, a seasonality insight providing information regarding values in the line chart demonstrating a seasonality, a trend insight providing information regarding a trend in values in the line chart, and an anomaly insight providing information regarding anomalous values in the line chart.

The term “insight data” is used herein to refer to information obtained from chart data for a chart to provide an insight. The insight data can include data items, such as attribute names and attribute values (numeric or non-numeric), occurring in the chart data. For instance, a minimum value is a data item that corresponds to the lowest value for a given attribute occurring in the chart data. The insight data can also include data items computed from the chart data. For instance, insight data can be generated for a minimum value by computing what percentage of an average value the minimum value represents. The insight data for each insight varies based on insight type and can include multiple data items, including combinations of data items based on data occurring in the chart data and data items computed from the chart data.

The term “rule set” is used herein to refer to one or more rules instructing the system described herein to extract certain insight data for an insight type. Each insight type has a corresponding rule set that sets forth the rule(s) for extracting insight data from chart data for the insight type. The rule set for each insight type can comprise, for instance, instructions executable by the system to extract certain insight data. In some instances, a rule in a rule set instructs the system to obtain an attribute name, attribute value, or other data item occurring in the chart data. In other instances, a rule in a rule set instructs the system to compute a data item based on the chart data. This can include a variety of different computation methods, including statistics calculation, anomaly detection, seasonality detection, comparison analysis, correlation analysis, and flow aggregation (e.g., tailored for Sankey charts).

As used herein, a “caption” refers to natural language text for an insight that includes insight data obtained from chart data for the insight. In accordance with aspects of the technology described herein, captions are generated from insights extracted from a chart, and the captions are presented with the chart.

### Overview

In the realm of data-driven decision-making, data analysis systems often provide for the creation of visualization charts to provide valuable insights from complex datasets. For example, some data analysis systems provide data visualization solutions that facilitate exploring data and monitoring changes in the data. Rather than sifting through endless rows and columns of data, these charts offer a more efficient mechanism for presenting trends, patterns, and anomalies. As such, these charts serve as powerful tools for efficiently monitoring and comprehending data, presenting a clear and concise overview of the underlying trends and patterns.

However, the efficiency of charts is balanced by a challenge of its own. Interpreting these charts and extracting meaningful insights is often a nuanced task that demands both time and expertise. In addition, the collaborative nature of modern businesses means that analysts frequently need to communicate their findings to third parties through descriptive narratives that explain the significance of the data. However, charts do not always readily reveal the exact numeric values, which is often crucial for making highly accurate decisions or creating a detailed data report.

To address this issue, some data analysis systems have attempted to provide solutions that can automatically translate charts into narrative descriptions. These approaches aim to highlight the key information from the charts, making it more accessible and comprehensible to a wider audience, while still preserving the numeric details to support informed decision-making. While there are existing automatic visualization captioning techniques integrated into various existing analytics tools, there are a number of shortcomings in these techniques. For instance, the absence of a universal framework or guidelines for generating captions and prioritizing insights remains a significant challenge. In addition, these conventional techniques lack coverage for some key insight types and chart varieties.

Some current solutions take a data-driven approach in which descriptions are purely derived from the data without taking into consideration the chart types, making it difficult to connect the generated descriptions back to specific visualizations. Additionally, these data-driven descriptions fail to account for different analytical intentions associated with different types of visualizations. For instance, while both donut and bar charts can interchangeably represent the same underlying data, the analytical intention of a donut chart is often more focused on understanding the proportional distribution and gaining a comprehensive overview of categories, whereas the analytical intention of a bar chart often prioritizes absolute values and the ranking of categories (e.g., identifying the top three highest bars).

In addition, current caption generation solutions offer a limited range of insights and typically support the mapping of insights to only basic visualization chart formats. This restricted scope fails to adequately support various common analytical tasks. For instance, many insight and caption generation solutions are primarily designed for static tabular data structures. Furthermore, existing automated insight and captioning solutions are predominantly tailored to tabular data structures, leaving a significant gap in support for other data formats, such as graph data, which is a prevalent data format underlying flow charts like Sankey diagrams and fallout charts.

Aspects of the technology described herein improve the functioning of the computer itself in light of these shortcomings in existing technologies by providing a modularized and extensible framework for extracting insights from chart visualizations and generating captions for those insights. For each type of chart, the framework supports defining insight types that align with analytical objectives of the visualizations provided by each chart type. Additionally, a rule set is defined for each insight type that sets forth instructions for extracting certain insight data for each insight type. As such, the framework is extensible as it allows incorporation of any chart type by setting forth the insight types for each chart type, as well as the rule set of each insight type.

In operation, the data analysis system receives input data for a chart that identifies a chart type and chart data for the chart. In some aspects, the input data can also include configuration information that provides additional parameters for generating insights. Based on the chart type, the data analysis system generates insights for the chart by determining insight data for each insight type defined for the chart type. In some aspects, this includes executing instructions of the rule set defined for each insight type to identify data items occurring in the chart data and/or compute data items based on the chart data using various computation methods, such as statistics calculation, anomaly detection, seasonality detection, comparison analysis, correlation analysis, and flow aggregation (e.g., tailored for Sankey charts). The data analysis system generates captions for insights using the insight data. Each caption includes natural language text identifying insight data for an insight. A user interface is provided that presents the chart with the captions.

In some aspects, a template-based approach is employed for caption generation in which a template is defined for each insight type. Each template includes natural language text and placeholders. The data analysis system generates a caption for an insight of a given insight type by retrieving a template for the insight type and replacing the placeholders in the template with data items from the insight data for the insight. The data items and placeholders can include data type identifiers to facilitate mapping certain data items from the insight data to certain placeholders in the template.

In some configurations, the data analysis system also generates ranking scores for each insight based on the significance (e.g., statistical significance) of insight data for an insight and/or an importance score assigned to each insight. Such ranking scores are used to select which captions to generate/present with the chart and/or to order the captions presented with the chart.

Aspects of the technology described herein provide a number of improvements over existing technologies. For example, unlike existing data-driven chart captioning solutions, this technology introduces a framework that effectively converts chart visualizations and the underlying chart data into descriptive captions that align with various types of insights. By allowing different insight types to be defined for each chart type, the framework generates captions with insights that are tailored to the analytical objectives associated with different chart types. Among other things, the framework extends the current boundaries of automated insights and chart captioning by supporting, for instance, features for generating insights related to temporal comparisons and insights tailored to flow charts, supporting a wider spectrum of analytical needs. The framework is both modular and extensible-chart types can be added by defining insight types and their associated rule sets, and each chart type can be individually modified by changing its associated insight types and/or their associated rule sets.

### Example System for Chart Visualization-to-Caption Generation

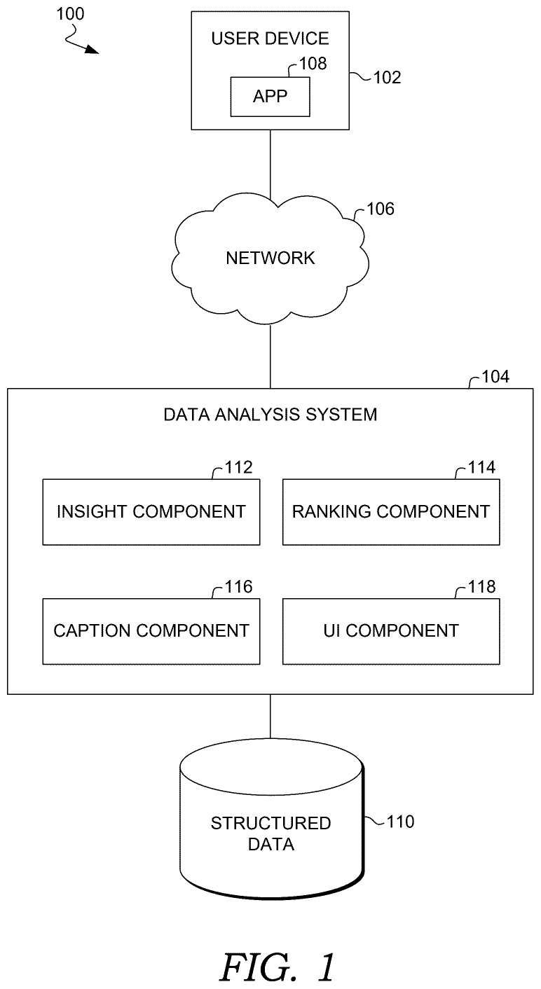

With reference now to the drawings, FIG. 1 is a block diagram illustrating an exemplary system 100 for generating captions with natural language text describing insights for charts in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

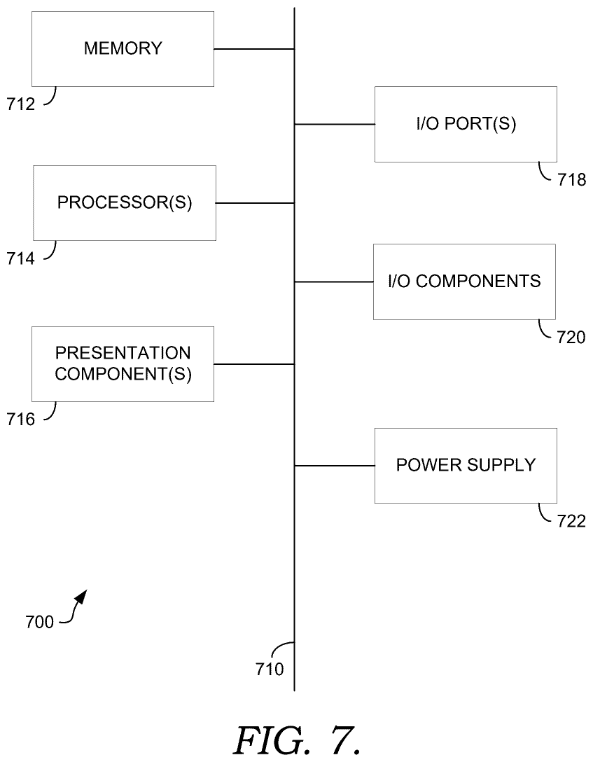

The system 100 is an example of a suitable architecture for implementing certain aspects of the present disclosure. Among other components not shown, the system 100 includes a user device 102 and a data analysis system 104. Each of the user device 102 and the data analysis system 104 shown in FIG. 1 can comprise one or more computer devices, such as the computing device 700 of FIG. 7, discussed below. As shown in FIG. 1, the user device 102 and the data analysis system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and servers can be employed within the system 100 within the scope of the present technology. Each can comprise a single device or multiple devices cooperating in a distributed environment. For instance, the data analysis system 104 could be provided by multiple server devices collectively providing the functionality of the data analysis system 104 as described herein. Additionally, other components not shown can also be included within the network environment.

The user device 102 can be a client device on the client-side of operating environment 100, while the data analysis system 104 can be on the server-side of operating environment 100. The data analysis system 104 can comprise server-side software designed to work in conjunction with client-side software on the user device 102, so as to implement any combination of the features and functionalities discussed in the present disclosure. For instance, the user device 102 can include an application 108 for interacting with the data analysis system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the data analysis system 104 remain as separate entities. While the operating environment 100 illustrates a configuration in a networked environment with a separate user device and data analysis system, it should be understood that other configurations can be employed in which aspects of the various components are combined.

The user device 102 comprises any type of computing device capable of use by a user. For example, in one aspect, a user device can be the type of computing device 700 described in relation to FIG. 7 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user can be associated with the user device 102 and can interact with the data analysis system 104 via the user device 102.

The data analysis system 104 facilitates retrieving and analyzing structured data that has been collected and stored in a data store 110. The data store 110 can store structured data in a variety of different formats that facilitate retrieval of data by the data analysis system 104. The structured data can employ a schema having multiple attributes. For instance, the structured data can comprise tabular data represented as a table in rows and columns, where each row corresponds to a record, and each column corresponds to an attribute. An attribute (e.g., a column in tabular data) corresponds to a dimension, metric, characteristic, feature, or property within the schema of the structured data. An attribute is identified using an attribute name and can comprise attribute values that are either numerical data (i.e., a numeric attribute) or non-numerical data (i.e., a non-numeric attribute). Numerical data comprises data in the form of numbers, including discrete or continuous values. Non-numerical data comprises data in the form of names or labels. It should be understood that while tabular data is provided as an example of structured data, the data store 110 can store other forms of structured data, such as graph data.

Among other functions, the data analysis system 104 retrieves structured data from the data store 110 and generates charts that provide visualizations of the structured data. The data analysis system 104 can generate a variety of different chart types, such as, for instance, line charts, area charts, bar charts, donut charts, histograms, fallout visualizations, and Sankey diagrams. As will be described in further detail below, the data analysis system 104 also extracts insights from underlying data used to generate charts and generates captions for those insights, which are presented with the charts.

As shown in FIG. 1, the data analysis system 104 includes an insight component 112, a ranking component 114, a caption component 116, and a user interface component 118. The components of the data analysis system 104 can be in addition to other components that provide further additional functions beyond the features described herein. The data analysis system 104 can be implemented using one or more server devices, one or more platforms with corresponding application programming interfaces, cloud infrastructure, and the like. While the data analysis system 104 is shown separately from the user device 102 in the configuration of FIG. 1, it should be understood that in other configurations, some of the functions of the data analysis system 104 can be provided on the user device 102. Additionally, while the components are shown as part of the data analysis system 104, in other configurations, one or more of the components can be provided at another location not shown in FIG. 1. The components can be provided by a single entity or multiple entities.

In some aspects, the functions performed by components of the data analysis system 104 are associated with one or more applications, services, or routines. In particular, such applications, services, or routines can operate on one or more user devices and servers, and can be distributed across one or more user devices and servers, or be implemented in the cloud. Moreover, in some aspects, these components of the data analysis system 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, the functionality of these components can be shared or distributed across other components.

The insight component 112 generates insights for charts based on chart types. A set of insight types is defined for each chart type that align with analytical objects in visualizing charts. A rule set is defined for each insight type that provides executable instructions for obtaining insight data for each insight type. The insight data comprises data items extracted from underlying chart data for charts. In some instances, a rule in a rule set instructs the insight component 112 to obtain an attribute name, attribute value, or other data item occurring in the chart data. In other instances, a rule in a rule set instructs the insight component 112 to compute a data item based on the chart data using any of various computation methods such as, for instance, statistics calculation, anomaly detection, seasonality detection, comparison analysis, correlation analysis, and flow aggregation (e.g., tailored for Sankey charts).

The input to the insight component 112 for a given chart comprises a chart type and the underlying chart data associated with the chart. The chart type identifies the type of visualization used by the chart, such as, for instance, a line chart, an area chart, a bar chart, a donut chart, a histogram, a fallout visualization, or a Sankey diagram. The chart data comprises, for instance, the attribute names and the attribute values from the structured data used to generate the chart. In some aspects, the input also includes configuration data that provides additional parameters for generating the insights. The configuration data could indicate, for instance, the language for the generated caption, whether the data contains multiple series, or whether to include insights comparing the chart data from one time period with chart data from another time period (e.g., current chart data compared with previous chart data).

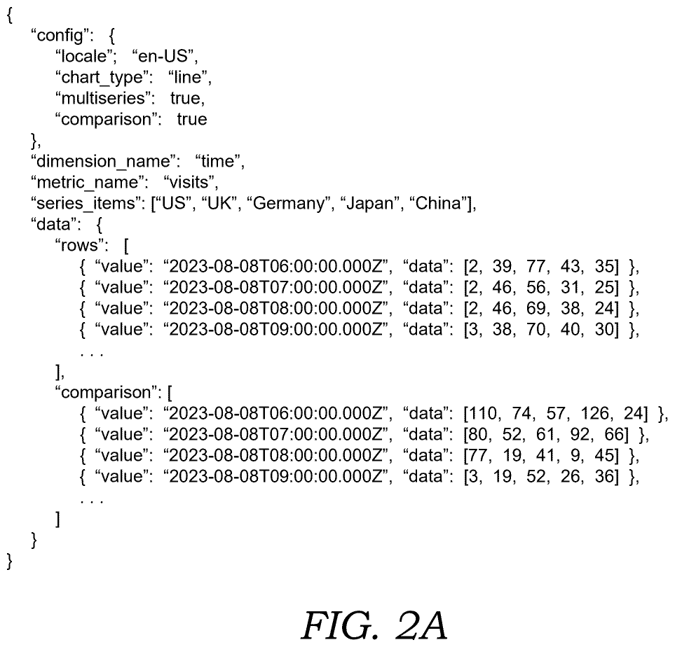

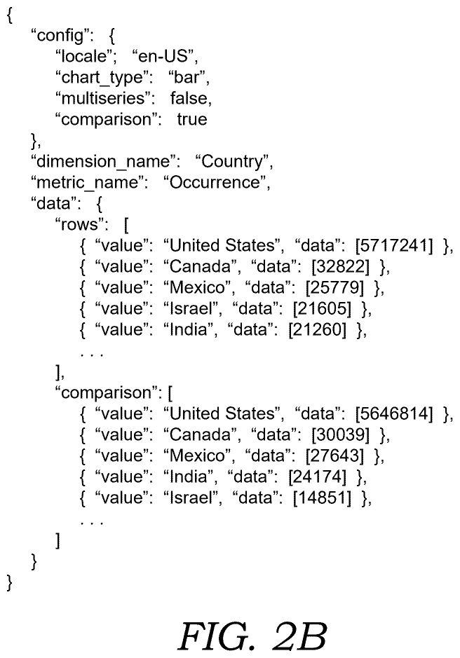

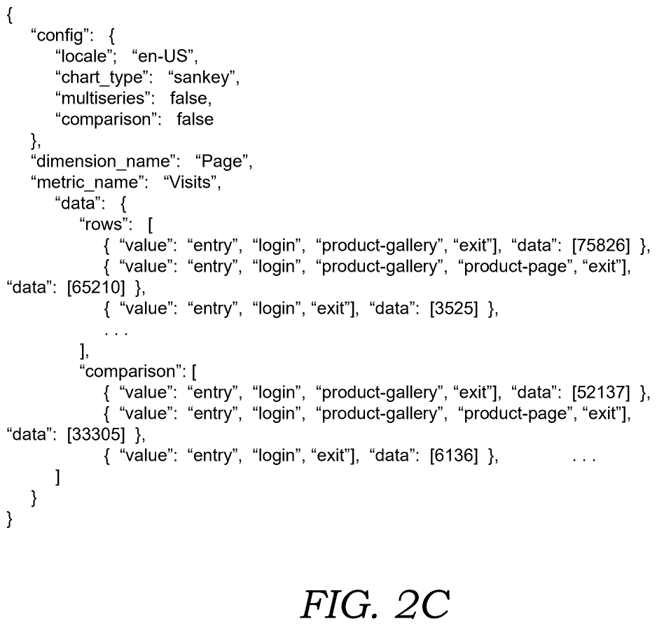

FIGS. 2A-2C provide examples of input data for three chart types. In each of these examples, the field chart_type identifies the chart type—i.e., the type of visualization. For instance, FIG. 2A provides an example of input data for a multi-series line chart. FIG. 2B provides an example of input data for a bar chart. FIG. 2C provides an example of input data for a Sankey diagram.

The fields dimension_name and metric_name designate the attribute names along the two dimensions of the chart. For instance, in the example of FIG. 2A, the line chart is described with the x-axis reflecting the “time” attribute and the y-axis reflecting the number of “visits.” In cases in which the chart incorporates multiple data series, such as a multiline chart or a group/stack bar chart, an additional field, series_items, is used to assign labels to each series. For example, FIG. 2A shows an example of input data for a multi-series line chart, where each series represents the “visits” for different countries over “time.”

The data field supplies the chart data used for insight analysis. The rows field represents the data table, where value signifies data items corresponding to the dimension attribute, and data denotes the data value of the metric attribute. In the context of a line chart, the value field could include timestamps for different data points. For bar and donut charts, the value field could include categorical labels for distinct data points. In histograms, the value field can include discrete numerical labels for the data points. In the case of Sankey and fallout charts, the value field can be defined as the trajectory of flow in a sequence, with the corresponding data field indicating the volume of flow passing through the specified trajectory.

The input data can also include configuration fields providing information to guide the caption generation process. For instance, the locale field indicates the language for the generated caption. The multiseries field specifies whether the data contains multiple series. The comparison field indicates whether to include insights comparing the chart data from one time frame with chart data from another time frame (e.g., comparing today's data with yesterday's data). When this field is indicated as true, an additional comparison field is included in the data that provides the same data table but for another time frame (e.g., the second set of data delineated by comparison in the input data of FIG. 2A)

Given input data for a chart identifying a chart type and providing chart data, the insight component 112 generates insights for the insight types defined for the chart type identified in the input data. In particular, the insight component 112 employs the rule set defined for each insight type defined for the chart type to extract insight data for each insight type based on the chart data. This can include obtaining data items occurring in the chart data and/or computing data items based on the chart data.

As an example to illustrate, suppose input data is received for a line chart showing the number of daily orders over a time period, and a minimum insight is generated from the input data. Given this input data, the insight component 112 could generate insight data with the following data items: the attribute “orders”, the minimum number of orders, the date on which that occurred, the average daily orders during that time period, and how much lower the minimum number is than the average daily orders.

In instances in which the input data includes other configuration data, the insight component 112 generates insight values in alignment with that configuration data. For instance, if the input data sets a comparison field as true and includes comparison data, the insight component 112 will generate a comparison insight based on a comparison of the subject data and the comparison data.

The insight data extracted from the chart data for the chart by the insight component 112 is used by the caption component 116 (described below) to generate captions for the insights. Examples of particular insight types for various chart types will be discussed in further detail below.

The ranking component 114 determines a ranking score for each insight generated by the insight component 112. The ranking scores can be used to select which insights to present captions for and/or to select an order in which multiple captions are presented with a chart. In some aspects, the ranking scores are based on the significance of each insight. The significance of an insight can be, for instance, a statistical significance, such that insights with a higher statistical significance have a higher ranking score. Examples of significance for particular insights for various chart types will be described in further detail below.

In some aspects, the ranking scores are based on an importance score assigned to each insight type that reflects a pre-defined importance of each insight type relative to other insight types for a given chart type. The importance scores for each insight type can be assigned by each user based on user preferences. For instance, if a user prefers to prioritize anomaly insights (often deemed more critical than basic statistics), the user can assign a higher importance score to anomaly insights relative to other insight types. When a user doesn't define importance scores for insight types, default importance scores can be employed (e.g., importance scores that are an average across all users who have assigned importance scores). In some aspects, the ranking score for an insight can comprise a composite of normalized scores derived from both the significance and the importance score.

The caption component 116 generates captions for insights. Each caption comprises natural language text that includes insight data generated for a given insight by the insight component 112. Examples of captions generated for particular insights for various chart types will be discussed in further detail below.

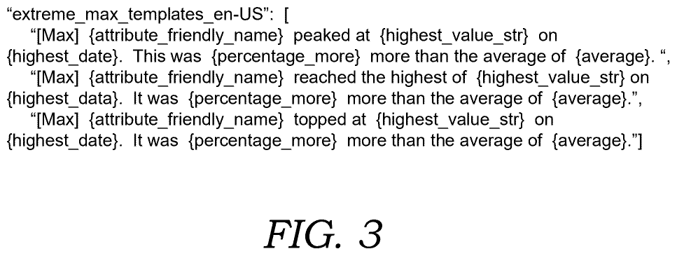

In some aspects, the caption component 116 employs a template-based approach to generate captions. For each insight type, a pre-defined template is stored that includes natural language text with placeholders for data items from the insight data for the insight. In such configurations, when the caption component 116 receives the insight data for a given insight, the caption component 116 generates a caption for the insight by retrieving the template for the insight type of the insight, and replacing the placeholders in the template with data items from the received insight data. While approaches using generative models (as discussed below) can be employed, the template-based approach can ensure better accuracy for the captions. FIG. 3 illustrates examples of templates for a maximum value insight type. Each template includes natural language text with placeholders for insight data. As shown in FIG. 3, multiple template options can be provided for a given insight type with various levels of conciseness and formality, thereby allowing for the generation of diverse captions.

In some aspects, the caption component 116 employs a generative model to facilitate generation of natural language text for captions. For instance, a prompt could be generated that includes insight data provided by the insight component 112. The prompt could also include information instructing the generative model how to generate the caption, such as information indicating the type or style of language to use to describe the insight data based on the insight type of the insight. The prompt could be provided as input to the generative model, which generates natural language text that includes the insight data. The generative model can comprise a language model that includes a set of statistical or probabilistic functions to perform Natural Language Processing (NLP) in order to understand, learn, and/or generate human natural language content. For example, a language model can be a tool that determines the probability of a given sequence of words occurring in a sentence or natural language sequence. Simply put, it can be a model that is trained to predict the next word in a sentence. A language model is called a large language model (LLM) when it is trained on enormous amount of data and/or has a large number of parameters. Some examples of LLMs are GOOGLE's BERT and OpenAI's GPT-3 and GPT-4. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write or otherwise in a form dictated, for instance, by a prompt.

In accordance with some aspects, a generative model used by the caption component 116 to generate captions comprises a neural network. As used herein, a neural network comprises multiple operational layers, including an input layer and an output layer, as well as any number of hidden layers between the input layer and the output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output. The neural network can be trained to generate captions using training data that comprises insight data paired with target captions for each insight type. The neural network can be iteratively trained by providing insight data to the model, which generates an output, comparing (e.g., using a loss function) the output against the target caption paired with the insight data in the training data, and updating the generative model based on the comparison (e.g., updating the weights via backpropagation).

Example Insights for Different Chart Types. The following provides examples of insight types for various chart types, including a discussion of methodologies employed for extracting insight data, determining significance, and generating example captions. It should be understood that the insight types and chart types described below are provided for illustration purposes only. Aspects of the technology described herein provide an extensible framework for extracting insights and generating captions for any insight type and any chart type.

Single line charts and area charts. One data format for a line chart comprises a temporal field paired with a numerical field, resulting in a singular line chart. An area chart, a visual alternative to the line chart, features filled colors or other visual representations that convey the same data structure. As a result, some aspects of the technology described herein use the same insight types for line charts and area charts. Line charts are frequently employed to understand the temporal dynamics of data. As such, the insight analysis in some configurations is based on statistically significant data points or notable changes along the temporal axis. In particular, the insights for line charts can include maximum insights, minimum insights, spike insights, decline insights, seasonality insights, trend insights, and anomaly insights.

Maximum and minimum insights provide context on the overall statistics of the data, encompassing the data average. They highlight the extent to which maximum and minimum data points deviate from this average. The significance of this insight can be gauged by considering the degree to which the maximum data point exceeds the average or the minimum data point falls below the average. Example captions for minimum and maximum insights for a line chart are provided below:
[Min] The lowest number of orders of 94,402 appeared on February 21st, 20% less than the average of 117,700.
[Max] Throughout this period, the number of orders topped 159,484 on February 8th. It was 36% more than the average.

Spike and decline insights identify instances of a substantial increase or decrease in values, indicating a noteworthy rate of change. To ascertain the significance of these spikes or declines, the change rate for each time step is calculated and the z-score is employed as a metric to represent their importance. Example captions for spike and decline insights for a line chart are provided below:
[Spike] The number of orders grew significantly between February 7th and 8th, up by 32% from 120,958 to 159,484.
[Decline] During the period of February 20th to 21st, the number of orders declined significantly, falling by 35% from 145,528 to 94,402.

Seasonality insights pinpoint cyclic patterns indicative of regular temporal dynamics. In the realm of business and digital marketing, for instance, recognizing these patterns assists users in observing operational KPIs and campaign performances. In some aspects, to detect potential cyclic patterns, temporal correlation is employed, calculating the correlation coefficient between the time-series and a delayed copy of it across various time windows (e.g., ranging from one hour to one year). A time series is deemed to exhibit a valid cyclic pattern if the coefficient surpasses a predefined threshold. The significance of the cyclic pattern is then conveyed through the magnitude of the coefficient. An example caption for a seasonality insight for a line chart is provided below:
[Seasonality] There was a weekly cyclic pattern in the number of orders. For each week, the peak number occurred at around the 2nd day and the valley occurred at around the 3rd day.

Trend and anomaly insights focus on detecting both level changes in the line and irregular data points within the overall trend. In contrast to spike and decline insights, which only account for continuous increases or decreases, trend insights provide a broader perspective on the value's overall increase or decrease, disregarding temporary reversals. To do so, a time-series decomposition algorithm is employed, which decomposes a time-series into three components: yₜ=Sₜ+Tₜ+Iₜ+e, where yₜ is the original data, Sₜ is the seasonal component, Tₜ is the trend component, Iₜ is the irregular component, and e represents the fitting error. The trend and anomaly insights are derived from the trend and irregular components, respectively. The significance of these insights is gauged by the normalized value of the fitting error. Example captions for trend and anomaly insights for a line chart are provided below:
[Trend] Throughout this period, there was a downward trend from Oct. 13, 2020 to Oct. 29, 2020 at a rate of −36,798 less visits per time-step, going down from 11,974,677 to 11,385,900.
[Anomaly] 2 anomalous number of visits were detected on Oct. 13, 2020 and Oct. 29, 2020. On average, the number of visits on these dates deviated by 67% from expectation.

Multi-line charts. In addition to the single line charts, multi-line charts featuring time series with distinct categorical labels are often used. Multi-line charts provide for comparing various time series to discern their similarities and differences. For instance, a multi-line chart can be used to compare revenues across different product categories to formulate a campaign strategy or analyze the correlation between email engagement and purchases as an indicator of campaign performance. Consequently, when generating captions for multi-line charts, some aspects generate comparative insights, accentuating the most notable series within the group. The approach can involve individual analysis of each time series to extract insights, with subsequent emphasis on the one exhibiting the highest significance value. The insights for multi-line charts can include maximum insights, minimum insights, spike insights, decline insights, seasonality insights, trend insights, anomaly insights, and correlation insights.

Maximum and Minimum: These insights highlight the time series with the highest maximum value and the lowest minimum value among all:
[Max] Visits has the highest maximum value 72,800,865, which occurred on June 7th and was 35% higher than its average 53,859,108.
[Min] Labs Prototype Exits has the most notable minimum value 0 occurred on May. 6th, which is 100% less than the average of 7.

Spike and Decline: These insights identify the series that exhibits the most significant changes among all:
[Spike] The greatest increase occurred in Revenue between June 3rd and 7th, growing by 1,019% from 2,109,546.31 to 23,601,840.9.
[Decline] The greatest decrease appeared in Revenue from June 7th and 10th, 92% from 23,601,840.9 to 1,937,437.79.
Seasonality: This insight identifies the most noteworthy cyclic pattern observed across all time series.
[Seasonality] Visits exhibits the most significant cyclic pattern occurring every 7 days with the peak typically appears on day 6 and valley on day 3.

Trend: This insight identifies the most significant trending observed among all time series:
[Trend] The most significant trend is observed in Visits from November 10th to December 2nd, with an increment of 65,015 per time-step on average, going from 131,750 to 1,562,080.

Anomaly: This insight focuses on the series that displays the highest count of anomalous data points and the series with anomalous data points deviating the most from the average:
[Anomaly] Visits has the largest number of 6 anomalies observed, where the values deviated by 83% from the period average. Revenue has most significant anomaly observed on June 29, deviating from expected value by +144%.

Correlation: The correlation insight assesses the similarity in trends among time series. In some aspects, the Pearson correlation coefficient is computed for each pair of time series, retaining those with a coefficient exceeding a specified threshold. The caption is designed to highlight the most correlated pair of time series, while also providing context on the correlations within the remaining pairs:
[Correlation] Visits and Orders exhibits strongest pair-wise correlation, while no correlation was found in other metric pairs.

Time Comparison for Line Charts and Area Charts. Beyond scrutinizing time series within a single time range, the comparison of data across distinct time periods is often analyzed. Consequently, some aspects integrate an additional field in the input data, accommodating information from a second time range and facilitating the generation of comparative insights between the primary and secondary time ranges. Within this context, each insight generated is accompanied by a comparative insight illustrating the distinctions between the current time range and the comparison time range, as illustrated by the following examples:
[Min] The lowest amount of orders of 2,047 appeared on 00:00 August 9th 56% less than the average of 4,676. Compared to previous period, there is a 614 decrease by 30%.
[Max] During this period the amount of orders peaked 8,796 on 15:00 August 8th. The highest amount of Workspace Project Loads was 88% more than the average. In comparison to previous period, there is a reduction of 428 by 4.9%.
[Spike] The amount of orders significantly increased in the span between 10:00 and 15:00 August 8th growing by 90% from 4,627 to 8,796. The previous period exhibits a smaller increase, from 4,975 to 9,224 by 85%.
[Decline] During the period of 14:00 to 00:00 August 9th the amount of orders declined significantly falling by 77% from 8,796 to 2,047. In the previous interval, the decrease is smaller, from 9,224 to 2,261 by 75%.

Some aspects generate comparative insights within the above four categories, as these categories are linked to specific timestamped data values, enabling a more meaningful comparison with values from related timestamps. In contrast, insights related to seasonality, trend, and anomaly are less amenable to point-to-point comparisons, because these insights often encapsulate broader patterns and deviations over extended periods, making direct timestamp-to-timestamp comparisons less meaningful.

In addition to the general insight types, some aspects generate comparison insight on the overall gain or loss:
[Total] Compared to the data from August 1st, there is 8,213 (6.8%) decrease in the total number of orders.

Bar Charts and Donut Charts. Bar charts and donut charts both involve a categorical field paired with a numerical field. These visualizations are often employed to gain insights into the distribution of values across different categories. Bar charts emphasize the absolute values of distinct categories, while donut charts prioritize the proportional representation of values. Consequently, when crafting captions for bar and donut charts, the insights identify statistically significant categories, such as major and rare occurrences, or highlight notable distribution patterns, such as skewness and long-tail distributions.

Following the descending sorting of categories by metric values in bar and donut charts, the following insights are extracted:

Max and Max Extent insights provide information about categories with the highest values. While emphasizing the highest value is useful, the highest category may not always be significantly larger than others. Consequently, the max extent insight offers information about the degree to which the highest category surpasses the second highest. For categories that are not significantly higher than the second one, analysts can refer to the max insight for more details about groups of categories with similar high values. The insight component 112 facilitates the creation of such groups by initially clustering categories based on their values. Captions are then generated accordingly. In some aspects, the complete-linkage criterion is employed to accomplish clustering in the one-dimensional distribution.
[Max Extent] The max attribute, Table of Contents, is 3% more than the second highest one.
[Max] Table of Contents, Annotations, Insight Generator, Dark Mode, Workspace Project PowerPoint Export and Intelligent Pathing contain the highest values, with around 248 in Occurrence (51% in total).

Skewness and long tail insights offer information regarding distribution anomalies in both bar and donut charts. Skewness points to instances where certain bars significantly surpass others in the distribution. Meanwhile, a long tail suggests the presence of numerous categories with relatively small values. To identify outliers, the z-score can be used, determining the degree of outlierness in values. Subsequently, captions are generated based on small groups of high-value categories and large groups of low-value categories that surpass the established outlierness threshold.
[Skewness] The values of Lab Prototype Launches are highly skewed towards FreeformReportlet and LineReportlet (58% in total).
[Long Tail Distribution] There are 21 attributes with Lab Prototype Launches less than or equal to 4,237.5 that form a tail distribution, which combined represent 42% in total.

Biggest Gain and Loss insights offer comparative analysis with respect to the preceding period. Comparable to the time-based comparisons in a line chart, the system enables inputting an additional series of values from the previous period, facilitating a thorough comparison between two bar or donut charts.
[Biggest Gain] My Account: Purchase History has the most increase of 25% compared to previous period.
[Biggest Loss] Checkout: Payment has the most decrease of 20% compared to previous period.

Histograms. While sharing a visual resemblance with a bar chart, a histogram is distinct in its representation of the distribution over continuous data, where values fall within specific intervals or ranges. The seamless continuity between bars in a histogram permits merging them, enabling the derivation of more consolidated insights based on value ranges. This shift in focus moves away from identifying individual standout bars, such as “Call Survey Score, 8, having the highest value in Sessions,” toward summarizing the distribution in a more condensed manner through grouping the bars by their similarity in value. For instance, one could convey that “Over 90% of the sessions exhibit Call Survey Scores ranging from 1 to 9”, given the similar number of sessions rating 1 to 9.

Given the distinctive analytical objective of a histogram, some aspects employ order-preserving hierarchical clustering to form clusters of bars. This approach recursively partitions the x-axis values based on their similarity in terms of y-axis values. The aim is to minimize value differences within each cluster while maximizing the differences in average values between clusters. This methodology enhances the distinction between groups, contributing to a more effective representation of the underlying data distribution. Through the clustering of bars, the following types of insights can be provided.

Major Values: This insight refers to the cluster of bars characterized by the highest average value, providing a representation of the central tendency within the distribution:
[Majority] Most sessions (99.6%) exhibit Call Survey Scores between 1 and 9 with an average of 5. Each Call Survey Scores has an average of 2181 sessions.

Rare Values: This insight pertains to the cluster of bars constituting less than 10% (subject to change) of the total, signifying the tail end of the distribution:
[Rare Value] Only 79 (0.4%) Sessions has 10+Call Survey Score.

Fallout visualizations. Fallout visualization is commonly used to visually represent the sequential steps or stages, commonly known as checkpoints, in a process, along with the success rate at each checkpoint. To create this visualization, analysts typically need to specify a list of checkpoints in a predetermined sequential order before generating the flow.

One analytical goal is to understand the overall flow of events or interactions, pinpointing checkpoints where drop-offs or failures occur in the progression. This visualization technique finds application in diverse fields such as, for instance, marketing, user experience design, and product analytics. It provides insights into user behavior and enables recognition of areas of friction or disengagement, allowing for informed, data-driven decisions to optimize the overall user journey. Given the above analytical goals, the following insights can be extracted for fallout visualizations.

Max Fallout: This insight refers to the checkpoint demonstrating the most substantial drop-offs, highlighting a potential bottleneck within the entire process:
[Max Fallout] The largest number of sessions fall out between Web Purchase Step 2 and Call, with 35, 408 sessions drop off and the highest dropout rate of 78%.

Flow Depth: This insight provides an overview of the pass-through rate across various checkpoints. In this context, the system applies a similar order-preserving clustering approach as employed in the analysis of histograms. This method helps identify key cut-off checkpoints, such as those experiencing relatively high drop-offs, allowing for summarizing the pass-through rates based on these identified critical points.
[Flow Depth] 73.4% of the sessions reached the Step 2, while 16.1% of the sessions reached Step 3.

Apart from analyzing fallout in a single series, some aspects also facilitate the analysis of fallout visualizations with multiple series. In this context, the emphasis can be on incorporating a comparative analysis of flow across different categories. Specifically, the following insights can be extracted for the multiple series fallout visualizations.

Max Fallout—All: Similar to the analysis of individual series fallout, this insight offers an overall view of general flow patterns by aggregating the fallout flow under different categories:
[Max Fallout—All] The largest drop out appears between Login and Analyze, involving 70,265 people and a dropout rate of 40.2%. The largest dropout rate occurs between Collaborate and Act, with 20,821 people fall out and a dropout rate of 100%.

Max Fallout—Breakdown: This insight centers on comparing the similarities and differences in the max fallout insight across various flow categories:
[Max Fallout—Breakdown] Both Digital Specialist and Product Manager experienced the max number of fall out in Analyze, with 7,339 and 3,596 people respectively. Collaborate has the highest fall-out rate for both Digital Specialist (62.5%) and Product Manager (69.6%).

Flow Depth: This insight offers a summary of the disparity in pass-through rate by comparing flows across different categories:
[Flow Depth] Digital Specialist has the most passing rate across all steps, with 15.8% people reaching Collaborate state, while Product Manager has the minimum passing rate of 10.1%.

Sankey Diagrams. A Sankey diagram is a specialized type of flow diagram designed to visualize the movement of resources or information among multiple entities. It can be useful, for instance, in portraying the distribution of resources, such as energy, materials, or costs, within a system. Nodes represent entities, and the flow between them is illustrated by arrows or lines with varying widths, where the width corresponds to the quantity of the flow. Sankey Diagram can be useful, for instance, for dissecting the customer journey, offering insights into the distribution of customer interactions across diverse touchpoints. In contrast to a fallout chart, which primarily focuses on the sequential drop-off in a linear process, the Sankey diagram provides a more comprehensive view by incorporating multiple checkpoints at each stage. One objective of constructing a Sankey Diagram is to pinpoint key convergence and divergence points, extracting valuable insights such as, for instance, the redistribution of customer traffic throughout different stages.

Unlike creating a fallout chart, which can involve users identifying touchpoints in the anticipated trajectory, generating a Sankey diagram eliminates the need for users to specify these touchpoints. Though, analysts may leverage predetermined touchpoints within the trajectory to streamline or filter the flow of interests, and the resulting forms of Sankey Diagram can vary based on the analytics goal, which are elucidated as follows.

Common entry: Analysts can designate a common entry node from which the flow of all entities originates. This facilitates the analysis of traffic once it enters the system. In this scenario, analysts frequently emphasize the first touchpoint, illustrating how entities enter the system's flow. For diagrams employing the common entry structure, the insights extracted typically revolve around the following aspects.

Most popular flow: This insight highlights the trajectory that has the most entities in the flow, and the percentage of entities that flow through this path:
[Most Popular Flow] The most popular flow followed the sequence Entry (Marketing Channel Detail)>t.co>Exit, accounting for 1% of the total visitors.

Top landing: This insight gives information about the most popular touchpoint after entering the system with the percentage of entities, and the subsequent touchpoint after the most popular touchpoint:
[Top Landing] t.co is the top entry point comprising 3.1% visitors, with www.facebook.com as the leading subsequence touchpoint, accounting for 2% of t.co visitors.

Secondary landing: This insight provides additional information on some other touchpoints that are less popular as the top landing touchpoint, but have similar amount of entities visited:
[Secondary Landing] www.facebook.com serves as the secondary entry point with 2.5% visitors, followed by www.redit.com, Pinterest.com, and www.dailymotion.com, accounting for 2.1%, 2.1%, 1.6% of the total visitors.

Flow depth: This insight summarizes the number of steps each entity takes from entry to drop-off. Different from the flow depth insight in Fallout chart, this insight focuses on the length of the trajectory other than the pass-through rate:
[Flow Depth] 30.9% of visitors experienced 1 Marketing Channel Detail before dropping off, while the rest of visitors reached the 2nd Marketing Channel Detail.

Common Exit: In this configuration, the flow of all entities converges at a common exit node, providing analysts with the opportunity to scrutinize the traffic prior to entities departing the system. Analysts in this scenario tend to concentrate on the final touchpoint before entities exit, shedding light on the reasons behind their departure. Similar to the common entry diagram, the common exit diagram yields insights into the most prevalent flow patterns and depth. Additionally, this diagram type allows for the extraction of insights that shift analytical focus to the touchpoints associated with exiting.

Top drop-off: This insight illustrates the most popular touchpoints before entities leave the system with the percentage of entities, and what is the leading touchpoints to this most popular drop-off touchpoint:
[Top Drop-off] Account Password Help exhibits the highest drop-off rate, comprising 15.4% of the people. purchase: step 2 is the most popular preceding touchpoint, accounting for 9.4% of people experienced Call Reason: Account Password Help.

Secondary drop-off: This insight gives additional touchpoints that have similar traffic compared to the top drop-off touchpoint.
[Secondary Drop-off] The next highest drop-off consists of Payment Issue, Order Created and Payment Question, accounting for 12.9%, 12.5%, 11.5% of the people.

Common mid-point: Analysts can filter the flow by determining a common touchpoint that all entities in the system go through. The trajectories of all entities in the Sankey Diagram will get aligned by this common touchpoint, which creates a picture for analysts to figure out what leads entities to this touchpoint, and what happens after this touchpoint. Generating insights and captions for this type of Sankey can involve a combination of analysis from common exit diagram (before the mid-point), and the common entry diagram (after the mid-point). Similar to the above two types of diagrams, some aspects also extract the most popular flow and flow depth. In addition, support the following insights for the particular analytics goal of this diagram.

Preceding touchpoint: This insight gives an overview of the previous touchpoint before the mid-point, and the percentage of entities that went through the previous touchpoints:
[Preceding Touchpoint] The majority of people (66.8%) entered from email Marketing Channel without preceding touchpoint. Display and mobile sms are the most popular preceding touchpoint, accounting for 5.1% and 5.1% of the total people, respectively.

Subsequent touchpoint: This insight gives an overview of the follow-up touchpoints after the mid-point:
[Subsequent Touchpoint] The majority of people (60.4%) dropped off after email Marketing Channel without subsequent touchpoint. Display, mobile sms and social are the most popular subsequence touchpoint, accounting for 6.1%, 5.9%, 5.1% of the total people, respectively.

Most popular preceding flow: This insight emphasizes the most common path entities go through before reaching the mid-point:
[Most Popular Preceding Flow] The majority of people (4.9%) reached email Marketing Channel through the path: entry>display>email.

Most popular subsequent flow: This insight highlights the most common path that entities go through after reaching the mid-point:
[Most Popular Subsequent Flow] The most popular flow after email Marketing Channel followed the sequence email (Marketing Channel)>display>exit, accounting for 3.9% of the total people.

The data analysis system 104 further includes a user interface component 118 that provides one or more user interfaces for interacting with the data analysis system 104. The user interface component 118 provides one or more user interfaces to a user device, such as the user device 102. In some instances, the user interfaces can be presented on the user device 102 via the application 108, which can be a web browser or a dedicated application for interacting with the data analysis system 104. For instance, the user interface component 118 can provide user interfaces for, among other things, providing charts with captions generated by the caption component 116 based on insights extracted from the charts by the insight component 112. In some aspects when there are multiple captions associated with a chart, the user interfaces enable a user to selectively sort the captions based on, for instance, the significance associated with the insight for each caption and/or based on the user's preferences for insight types (e.g., as reflected by importance scores associated with each insight).

As insights are linked to specific data items (e.g., values, range of values, attributes, data series, etc.) in charts, in some configurations, the user interfaces provide visual indicators in the charts identifying the data items from the insights. In particular, for a given insight, the system determines chart data corresponding to a data item in the insight data for the insight. The system then generates a visual indicator in the chart corresponding to the data item. The data item could comprise, for instance, a single value, a range of values, a particular attribute, a data series, or other data in the insight data for an insight. For instance, in the context of a minimum insight for a line chart, the data item could be the minimum value, and a visual indicator could be provided that identifies the minimum value in the chart. As another example, in the context of a decline insight for a line chart, the data item could be a range of values exhibiting the decline, and a visual indicator could be provided in the chart that identifies the range of values.

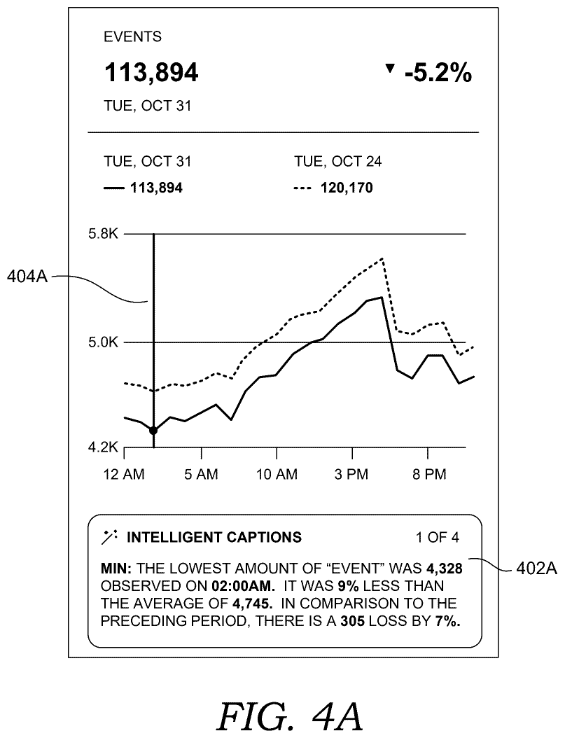

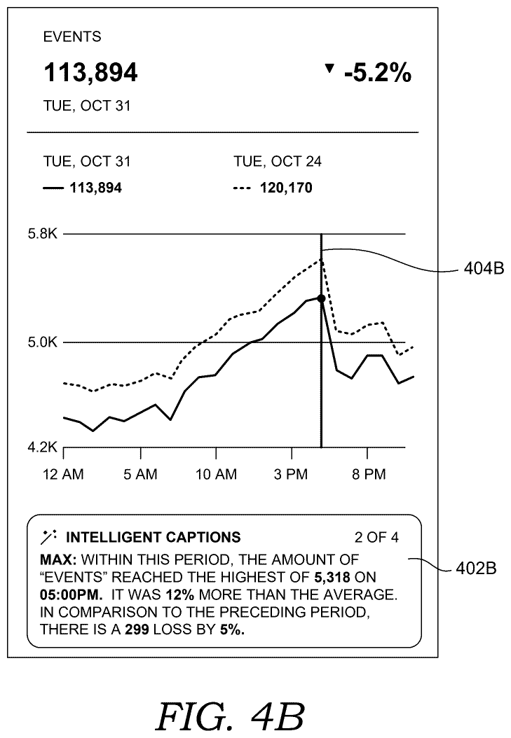

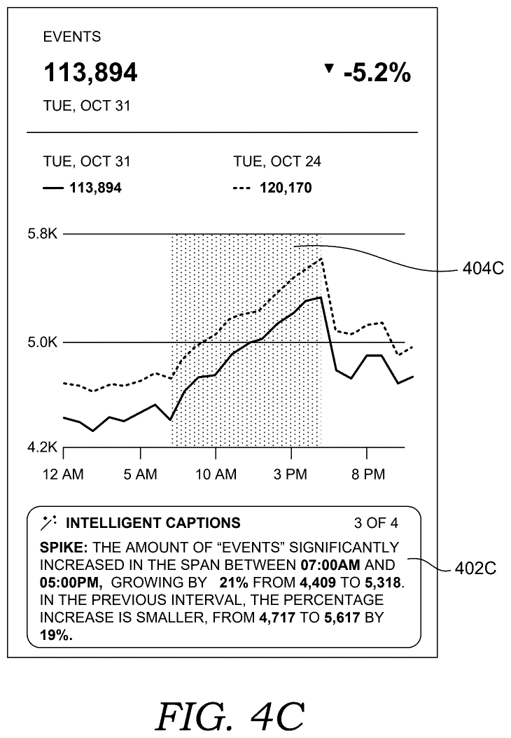

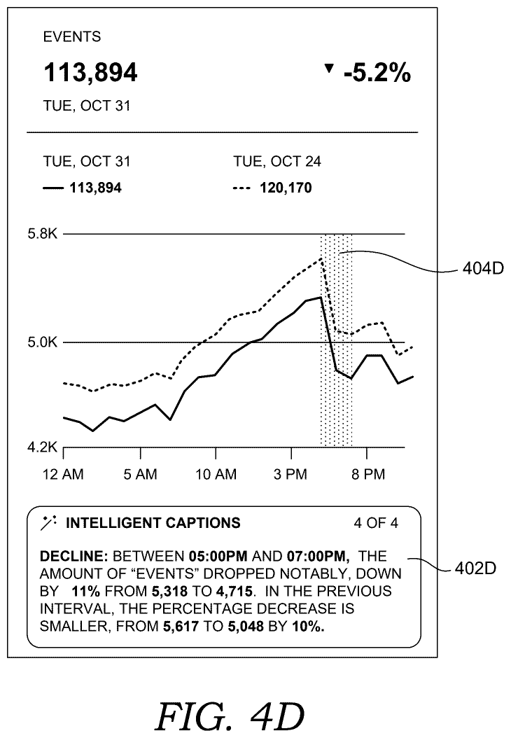

By way of illustration, FIGS. 4A-4D provide example user interfaces presenting a chart with captions for several insights and visual indicators on the charts identifying the data points/entities associated with the insight. In particular, FIG. 4A presents a multiline chart comparing the number of events for a day (“Tue, October 31”) with that of a previous day (“Tue, October 24”). In FIG. 4A, a caption 402A for a minimum insight is provided with the chart. Additionally, a visual indicator 404A is presented in the chart that includes a point identifying the minimum value and a vertical line that allows for a comparison of the values at that point between the two days. The user interface for FIG. 4B presents a caption 402B for a maximum insight with the chart and a visual indicator 404B in the chart that includes a point identifying the maximum value and a vertical line that allows for a comparison of the values at that point between the two days. FIG. 4C presents a caption 402C for a spike insight for the chart. In that example, a visual indicator 404C is presented in the chart that identifies the time period corresponding to the range of values for the spike. In FIG. 4D, the chart is presented with a caption 402D for a decline insight. Additionally, a visual indicator 404D is presented in the chart that identifies the time period corresponding to the range of values for the decline.

### Example Methods for Chart Visualization-to-Caption Generation

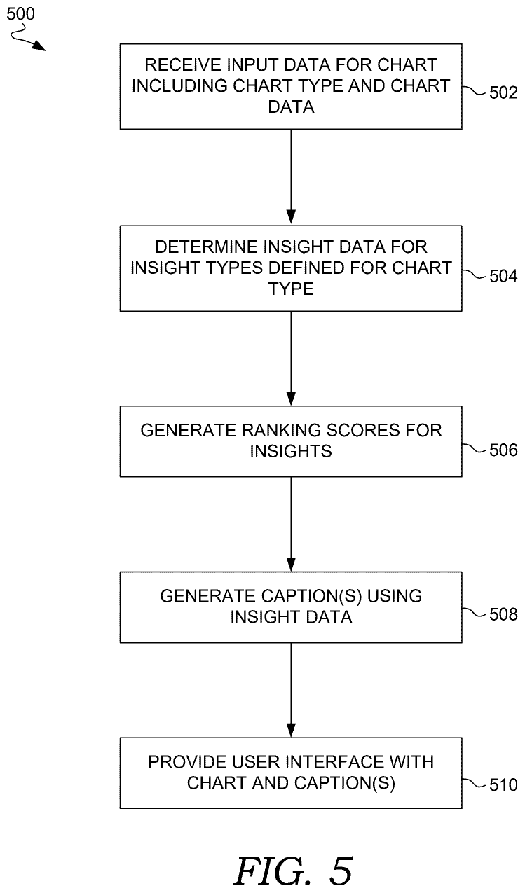

With reference now to FIG. 5, a flow diagram is provided that illustrates a method 500 for extracting insights from a chart and generating captions for the insights in accordance with some aspects. The method 500 can be performed at least in part, for instance, by the data analysis system 104 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, input data for a chart is received. The input data includes an indication of the chart type of the chart and the chart data used to generate the chart. In some aspects, the input data also includes configuration data that provides further instructions regarding how to generate insight data for the chart.

Insight data is determined for each insight type defined for the chart type identified in the input data, as shown at block 504. The insight data is determined for each insight type using the chart data for the chart. In some aspects, a rule set defined for each insight type is accessed. Each rule set can include executable instructions to determine the insight data for its corresponding insight type. A rule set can include, for instance, instructions to identify certain data items occurring in the chart data and/or to compute data items based on the chart data. The insight data for each insight type provides insights for the chart (i.e., an insight for each insight type).

As shown at block 506, ranking scores are generated for the insights. The ranking score for each insight can be based on a significance (e.g., statistical significance) of the insight data for each insight and/or based on an importance score defined for each insight type (e.g., defined by the current user and/or a default importance scores). While the method 500 of FIG. 5, includes generating ranking scores for the insights; in other configurations, no ranking score is generated.

A caption is generated for at least one insight using the insight data, as shown at block 508. In some instances, captions are generated based on ranking scores. For instance, in some configurations, captions are only generated for insights having a ranking score above a threshold ranking score and/or only for insights with the top N ranking scores (where N is configurable). In other instances, captions are generated independent of ranking scores. For instance, a caption could be generated for each insight.

As shown at block 510, a user interface is provided that presents the chart with at least one caption generated at block 508. In some instances, captions are selected for presentation based on ranking scores. For instance, in some configurations, captions are only selected for presentation for insights having a ranking score above a threshold ranking score and/or only for insights with the top N ranking scores (where N is configurable). In some instances, captions are ordered for presentation based on ranking scores. For instance, captions can be provided for presentation in an order from highest ranking score to lowest ranking score. In some configurations, the selection and/or ordering of presentation based on ranking scores can be user-selectable. For example, an option can be provided that allows a user to view captions ordered based on significance or based on importance scores. In further configurations, the captions can be selected and/or ordered for presentation independent of the ranking scores.

In some configurations, a visual indicator is presented in the chart based on insight data for a caption presented with the chart. This can include determining chart data corresponding to a data item in the caption and providing a visual indicator in the chart corresponding to that chart data.

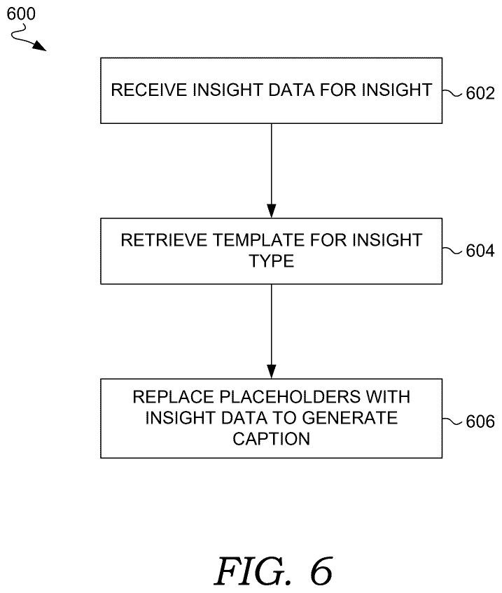

Turning next to FIG. 6, a flow diagram is provided that illustrates a method 600 for using a template for a given insight type to generate a caption. The method 600 can be performed, for instance, by the caption component 116 of FIG. 1. As shown at block 602, insight data for an insight is received. The insight corresponds to a given insight type, and the insight data can be determined, for instance, using a rule set defined for that insight type, as described hereinabove.

A template for the insight type is retrieved, as shown at block 604. For instance, a repository could store one or more templates for each insight type defined for each chart type configured for the system, and a template could be retrieved from the repository based on the insight type. The template includes a combination of natural language text and placeholders.

As shown at block 606, the placeholders in the template are replaced with data items from the insight data. In some instances, each data item from the insight data can be identified as a certain data type (e.g., attribute name, minimum value, maximum value, spike start value, spike end value, etc.), and each placeholder in the template can identify a certain data type. This facilitates mapping the correct data items from the insight data to the correct placeholders in the template. By replacing the placeholders with data items from the insight data, a caption for the insight is generated with natural language text that includes the insight data.

### Exemplary Operating Environment

Having described implementations of the present disclosure, an exemplary operating environment in which embodiments of the present technology can be implemented is described below in order to provide a general context for various aspects of the present disclosure. Referring initially to FIG. 7 in particular, an exemplary operating environment for implementing embodiments of the present technology is shown and designated generally as computing device 700. Computing device 700 is but one example of a suitable computing environment and is not intended to suggest any limitation as to the scope of use or functionality of the technology. Neither should the computing device 700 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to codes that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what can be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory can be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which can be built in. Illustrative components include a microphone, joystick, game pad, satellite dish, scanner, printer, wireless device, etc. The I/O components 720 can provide a natural user interface (NUI) that processes air gestures, voice, or other physiological inputs generated by a user. In some instances, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 can be equipped with depth cameras, such as, stereoscopic camera systems, infrared camera systems, RGB camera systems, and combinations of these for gesture detection and recognition. Additionally, the computing device 700 can be equipped with accelerometers or gyroscopes that enable the detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving input data comprising a chart type and chart data for a chart;
determining, using the chart data, insight data for each insight type from a plurality of insight types defined for the chart type, the insight data for each insight type determined using a rule set defined for each insight type;
generating, using the insight data for each insight type, natural language text for a caption for each insight type; and
providing a user interface presenting the chart and at least one of the captions.

2. The one or more computer storage media of claim 1, wherein the input data comprises configuration data providing information instructing how to determine at least a portion of the insight data.

3. The one or more computer storage media of claim 1, wherein the natural language text for a first caption for a first insight type from the plurality of insight types is generated by:
accessing a template based on the first insight type, the template having one or more placeholders; and
replacing the one or more placeholders with the insight data determined for the first insight type.

4. The one or more computer storage media of claim 1, wherein the natural language text for a first caption for a first insight type from the plurality of insight types is generated by:
causing a generative model to produce the natural language text using input comprising an indication of the first insight type and the insight data determined for the first insight type.

5. The one or more computer storage media of claim 1, wherein the operations further comprise:
generating a ranking score for each of the plurality of insight types.

6. The one or more computer storage media of claim 5, wherein the ranking score for a first insight type from the plurality of insight types is based on a statistical significance of the insight data determined for the first insight type.

7. The one or more computer storage media of claim 5, wherein the ranking score for a first insight type from the plurality of insight types is based on an importance score assigned to the first insight type.

8. The one or more computer storage media of claim 5, wherein a first caption is generated for a first insight type from the plurality of insight types based on the ranking score for the first insight type.

9. The one or more computer storage media of claim 5, wherein a first caption for a first insight type from the plurality of insight types is provided for presentation on the user interface based on the ranking score for the first insight type.

10. The one or more computer storage media of claim 5, wherein the captions for two or more insight types from the plurality of insight types are ordered for presentation on the user interface based on the ranking scores for the two or more insight types.

11. The one or more computer storage media of claim 1, wherein a first caption for a first insight type is presented with the chart on the user interface, and wherein the operations further comprise:
determining a portion of the chart data corresponding to a data item in the insight data for the first insight type; and
providing a visual indicator in the chart identifying the portion of the chart data.

12. A computer-implemented method comprising:
determining, by an insight component, insight data for a chart by:
receiving input data comprising an indicator of a chart type and chart data for the chart,
accessing a rule set for each insight type from a plurality of insight types defined for the chart type, and
executing instructions of the rule set for each insight type from the plurality of insight types to determine insight data for each insight type;
generating, by a caption component, a caption for each insight type by:
accessing a template for each insight type, each template having one or more placeholders, and
replacing the one or more placeholders in each template with the insight data determined for each insight type; and
providing, by a user interface component, a user interface presenting the chart and at least one of the captions.

13. The computer-implemented method of claim 12, wherein the method further comprises:
generating, by a ranking component, a ranking score for each of the plurality of insight types.

14. The computer-implemented method of claim 13, wherein the ranking score for a first insight type from the plurality of insight types is based on one or more selected from the following: a statistical significance of the insight data determined for the first insight type; and an importance score assigned to the first insight type.

15. The computer-implemented method of claim 13, wherein a first caption for a first insight type from the plurality of insight types is generated and/or provided for presentation based on the ranking score for the first insight type.

16. The computer-implemented method of claim 12, wherein a first caption for a first insight type is presented with the chart on the user interface, and wherein the method further comprises:
determining a portion of the chart data corresponding to a data item in the insight data for the first insight type; and
providing a visual indicator in the chart corresponding to the portion of the chart data.

17. A computer system comprising:
one or more processors; and
one or more computer storage media storing computer-useable instructions that, when used by the one or more processors, causes the computer system to perform operations comprising:
receiving, by an insight component of the computer system, input data for a chart, the input data comprising an indicator of a chart type and chart data,
determining, by the insight component, insight data for each insight type from a plurality of insight types defined for the chart type using a rule set defined for each insight type;
generating, by a ranking component of the computer system, a ranking score for each insight type;
generating, by a caption component of the computer system, natural language text for a caption for each insight type using the insight data for each insight type; and
providing, by a user interface component, a user interface presenting the chart and at least one of the captions based on the ranking scores.

18. The computer system of claim 17, wherein the captions for the plurality of insight types are ordered for presentation via the user interface based on the ranking scores.

19. The computer system of claim 17, wherein the ranking score for a first insight type from the plurality of insight types is based on one or more selected from the following: a statistical significance of the insight data determined for the first insight type; and an importance score assigned to the first insight type.

20. The computer system of claim 17, wherein a first caption for a first insight type is presented with the chart on the user interface, and wherein the operations further comprise:
determining a portion of the chart data corresponding to a data item in the insight data for the first insight type; and
providing a visual indicator in the chart corresponding to the portion of the chart data.
